(19) United States
(12) Patent Application Publication
(10) Pub. No.: US 2004/0093974 A1
(43) Pub. Date: May 20, 2004

(54) Electromechanical shifting apparatus

(76) Inventor: Eric J. Nesseth, Burnsville, MN (US)

Correspondence Address: Tipton L. Randall, 19371 55th Avenue, Chippewa Falls, WI, 54729, US

(21) Appl. No.: 10/691,050

(22) Filed: Oct. 23, 2003

Related U.S. Application Data
(60) Provisional application No. 60/427,082, filed on Nov. 15, 2002.

(51) Int. Cl. F16H 59/00

(52) U.S. Cl. 74/473.12; 74/335; 74/484 R

(57) ABSTRACT

The invention is an electromechanical shifting apparatus, primarily for use on a multi speed, straddle-type vehicle, but applicable to any vehicle having a transmission that shifts via a pivot shaft. The electromechanical shifting apparatus consists of six main parts: switch, switch bracket (depending on application), actuator, mounting bracket, shift linkage, and wiring harness. The electromechanical shifting apparatus attaches to the machine using various other pieces of mounting hardware, dependent on the application.

### CROSS REFERENCE TO RELATED APPLICATION

This application claims the benefit under 35 U.S.C. §119 (e) of co-pending provisional application Serial No. 60/427,082, filed Nov. 15, 2002. Application Ser. No. 60/427,082 is hereby incorporated by reference.

### STATEMENT REGARDING FEDERALLY SPONSORED RESEARCH OR DEVELOPMENT

Not applicable.

### REFERENCE TO A MICROFICHE APPENDIX, IF ANY

Not applicable.

### FIELD OF THE INVENTION

The invention relates to an electromechanical shifting apparatus, and more particularly, to an electromechanical shifting apparatus for use with a motorcycle or an all terrain vehicle (ATV).

### BACKGROUND OF THE INVENTION

Many motorcycles and ATVs are provided with a foot-operated shifting mechanism. A certain degree of dexterity is required to operate such a shifting mechanism. Various individuals may lack the skill to operate the shifting mechanism or have a physical disability that prevents them from operating the foot-operated mechanism. Some examples of shifting mechanisms for which patents have been granted include the following.

Betzing, in U.S. Pat. No. 3,659,683, describes an electromechanical brake-lifting device for use with, for example, a large crane. The device is a mechanically complex unit for turning a screw drive, which moves a lever arm to lift brake shoes off a brake drum.

U.S. Pat. No. 5,299,652 by Bevins describes shifting and all wheel braking systems that are controlled on the handlebars of a motorcycle to allow a physically challenged rider to safely operate the motorcycle having a sidecar. The shifting system includes a shift switch, which comprises an upshift button and a downshift button. During operation, the throttle is advanced and lowered while the clutch lever is closed to disengage the clutch. The upshift button is then depressed to discharge a burst of air from a tank to an actuator and shift arm in order to advance one gear in the transmission. The downshift button is used in the same way to accomplish downshifting one gear. This gear shifting system was designed for physically challenged motorcycle riders.

In U.S. Pat. No. 5,662,195, Rush discloses a gear shift conversion kit and method for converting a foot-operated shift mechanism and a hand-operated clutch mechanism on a motorcycle to a hand-operated shift mechanism and a foot-operated clutch mechanism. Novel components, which are contained in the gear shift conversion kit, include a foot pedal arm, a cable receiver adjustment block, and a shifter arm. The mechanisms are purely mechanical linkages.

Schaller et al., in U.S. Pat. No. 6,065,363, disclose a change-speed gearbox of a motor vehicle, including a shifting element moveable within a plurality of shift gates for engaging and disengaging a selected gear. A gearshift member cooperates with the gear shifting element. The gearshift member is movable to perform a rotary shift movement and a linear shift movement. A shift device for the gearbox includes a motor, having a shaft extending therefrom rotatable about an axis. The gearshift member is axially, slidably supported by the motor shaft and rotatably engaged therewith. A solenoid is engaged with the gearshift member for slidably, axially moving the gearshift member into a plurality of positions corresponding with the shift gates.

The shift device comprises a gearshift member cooperating with the gear shifting element of the change-speed gearbox and is movable to perform shift movements “L” and “R,” substantially transverse to one another. A linear movement “L” of the member is produced by a solenoid, and a rotary movement “R” thereof is produced by means of an electric motor. The motor controllably turns an actuating shaft, carrying on it an axially movable sliding sleeve. Through a splined connection, the actuating shaft carries non-rotatably but axially movably thereon a sliding sleeve. The sliding sleeve is engaged through a fork by a preselector member. The fork is actuated by means of a solenoid, which positions the sliding sleeve in different axial positions which correspond to the selected shift gates (5/6, 3/4, 1/2 and R (reverse)).

An electromechanically actuated stop element is provided to position the preselector member in a position corresponding to the shift gates to be selected. The device can thereby serve more than three gates. In a preferred embodiment, the electromagnetic stop element is preferably located on a turntable formed as a reversing lever. In an alternative embodiment, the stop element is integrated within the magnet. The device has the advantages of being inexpensive and having the capacity to provide three or more shift gates, thereby enabling a transmission with six forward gears and reverse.

U.S. Pat. No. 6,070,485 by Funk, Sr. et al. describes a solenoid-actuated transmission shifting apparatus for installation in automobiles with conventional, H-pattern-type manual transmissions or automatic transmissions and also for use with motorcycle transmissions. The shifting apparatus is actuated by a two-pushbutton controller, one pushbutton used to upshift and another pushbutton used to downshift. The solenoids are wired into and powered by the vehicle's electrical system. Electro-mechanical or solid state relays, triggered by the pushbuttons, are used to switch the power to the solenoids. In the motorcycle version, two solenoids are mounted in a linearly opposing fashion, such that they operate the transmission shifter lever arm in the appropriate direction, either up or down, in order to switch through the transmission gears.

In U.S. Pat. No. 6,131,682, Walker discloses an electric solenoid shifter for motorcycles for clutchless shifting of the motorcycle by pushing a button mounted on the handlebars of the motorcycle. The device includes a solenoid mounting plate for securing a solenoid to the motorcycle and a microswitch which is operably linked to the solenoid and mounted on the motorcycle. A cable clamp for securing a solenoid cable is secured to the solenoid and to a spring, and the spring is secured to the cable clamp and to a solenoid cable bracket. A locknut is secured to the solenoid cable bracket, and a cable adjuster element is secured to the locknut. A gear shifter cable bracket assembly is operably secured to the solenoid cable and to a clevis, with the clevis being mounted to the motorcycle. An electric interrupt element for controllably interrupting the ignition system of the motorcycle is secured to the motorcycle and operably linked to the microswitch and to a toggle switch. A control button is secured to the handlebars of the motorcycle for controlling the solenoid. The control button is operably linked to a relay element and to the solenoid.

Gagnon et al., in U.S. Pat. No. 6,257,081, describes a transmission system for a straddle vehicle which provides semiautomatic and automatic operating modes. With the semiautomatic transmission system, an operator only uses a switching mechanism mounted on a steering bar of the vehicle for activating a clutch actuator and a shift actuator. The clutch actuator disengages a transmission clutch while the shift actuator operates a shifter for changing the transmission ratio. With the automatic transmission system, an electronic control unit reads input signals, such as speed of the engine (RPM), speed of the vehicle, opening of a throttle valve and position of a shifter, and accomplishes a smooth shifting by activating a clutch actuator, a shift actuator and a modulated controlling valve.

U.S. Pat. No. 6,374,691 by Grundberg et al., discloses an apparatus for shifting a transmission coupled to a boat engine that includes a controller for shifting the transmission between operating modes, a control lever for switching the transmission, and an actuator for actuating the control lever in response to shifting of the controller. The apparatus includes a longitudinal tube connected to the controller, a cylindrical slide connected to the actuator for actuating the control lever in response to shifting of the controller, the longitudinal tube being coaxial with the cylindrical slide, a detector for detecting relative displacement between the longitudinal tube and the cylindrical slide, and a spring acting between the longitudinal tube and the cylindrical slide to prevent relative displacement between them until a force acting on one of them exceeds the spring force of the spring. The detector signals at least one of the cylinders of the engine to switch off during shifting the transmission to forward or reverse

In U.S. Pat. No. 6,394,214, Hahm discloses a motorcycle shifting arrangement connected to the transmission of the motorcycle for shifting the transmission between a higher gear and a lower gear. The motorcycle includes an original shifting structure having an original shift pedal pivotally mounted on an original pivot shaft, coupled to the transmission at a location adjacent a foot rest attached to a bottom portion of the motorcycle. A supplementary shifting structure is constructed and arranged to permit alternative shifting of the motorcycle while the motorcycle operator has his or her legs in a raised, extended position resting upon a highway peg attached to a supporting structure at a forward location of the motorcycle. The shifting structure is a purely mechanical linkage.

Thus, there is an unmet need for a suitable electromechanical shifting apparatus for use with a motorcycle or an all terrain vehicle (ATV).

### SUMMARY OF THE INVENTION

The invention is an electromechanical shifting apparatus for use with a motorcycle or all terrain vehicle (ATV). The device includes a bidirectional, linear actuator that is linked to the vehicle transmission counter shaft, using a linkage and/or a shift lever of a design dependent on the particular application. The device is suitable for use with any vehicle transmission that shifts via a counter shaft utilizing partial rotation to change gears, with the counter shaft returning to rest at one location after each shift, regardless of shift direction. The linear movement of the actuator is converted to rotational movement by the linkage and/or shift lever. A dual pole switch, for example, a momentary switch, is used to reverse the polarity, giving the actuator power in either direction, depending on the switch position. The actuator can move the shift lever any number of times in either direction, limited only by the transmission itself. The actuator is powered by the standard 12 volts system of motorcycles or ATVs, although other voltage magnitudes work equally well. The device is preferably a gear-driven actuator, but other types of electromechanical actuators, such as belt or screw drive devices, can be employed with equivalent results. The bracket for mounting the actuator to the vehicle varies with the particular application, with some variation between different vehicles.

In a preferred embodiment of the invention, an electromechanical shifting apparatus for a vehicle having an electrical system and a transmission equipped with a counter shaft, utilizing partial rotation to shift gears is disclosed. The shifting apparatus comprises an actuator assembly that includes a bidirectional linear actuator member powered by an electrical motor, with the actuator assembly secured to the frame of the vehicle. A shift linkage operatively connects the bidirectional linear actuator member to the counter shaft of the vehicle transmission. A wiring harness assembly is connected to the electrical system of the vehicle, with the wiring harness assembly powering the electrical motor of the actuation assembly. A switch member is interconnected with the wiring harness, the switch member including first and second actuation positions and an off position. The first actuation position provides a selected current flow direction to the actuator assembly motor to drive the linear actuator member in a first direction. The second actuation position reverses the current flow direction to the actuator assembly motor relative to the selected current flow direction, thereby driving the linear actuator member in a second direction, opposite the first direction.

### BRIEF DESCRIPTION OF THE DRAWINGS

FIG. 1 is a side view of the electromechanical shifting apparatus of the present invention mounted on a motorcycle.

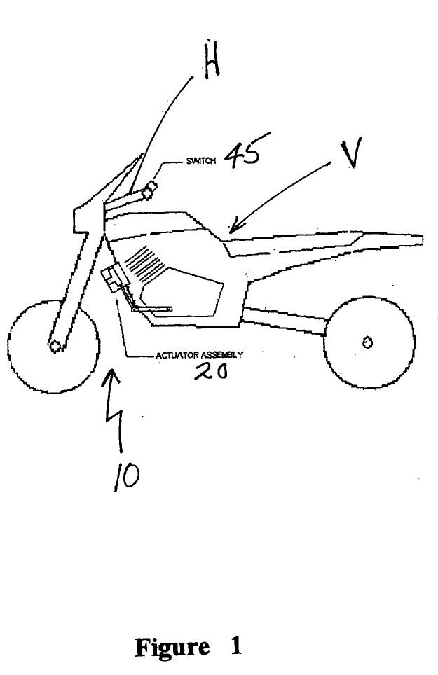

FIG. 2 is a side view of the electromechanical shifting apparatus of the present invention connected to a vehicle multi-speed transmission.

FIG. 3 is a cut away view of the electromechanical shifting apparatus linear actuator and momentary switch of the present invention.

FIG. 4 is a rear view of the electromechanical shifting apparatus of the present invention, connected to a vehicle multi-speed transmission.

FIG. 5 is a perspective view of one embodiment of the switch member of the electromechanical shifting apparatus of the present invention

### DESCRIPTION OF THE PREFERRED EMBODIMENTS

The electromechanical shifting apparatus primary application is for installation on a multi-speed straddle-type vehicle, but is applicable to any vehicle with a transmission that shifts via a pivot shaft. The apparatus consists of six main parts: a switch, a switch bracket (depending on the application), an actuator, a mounting bracket, a shift linkage, and a wiring harness. The apparatus attaches to the machine using various other pieces of mounting hardware, dependent on the application. The following is a breakdown of the primary parts and their functions:

Switch: The function of the switch is to send the proper polarity current to the actuator via the operator's input. A double pole double throw (dpdt) switch is used to reverse the polarity of the actuator motor, giving the motor power in either direction. A (momentary) on/off/on (momentary) switch is used for convenience, but other dpdt switches are capable of performing the same function. A suitable switch is made by NKK Switches. NKK's U.S. office is located at 7850 E. Gelding Drive, Scottsdale, Ariz. 85260. The switch is mounted on or near the handlebars or driver controls, but can be mounted elsewhere depending on the particular application and/or preference.

Switch Bracket: The switch bracket is a custom-made item that attaches to the machine with the function of holding the switch. Some vehicles may have existing mounting locations that make a switch bracket unnecessary.

Actuator: The function of the actuator is to move the gearshift lever via the linkage and, in turn, change the gears, forward or reverse, in the transmission. In the present application, the actuator is a motor driven, bidirectional linear actuator. This present invention also covers other electromechanical, bidirectional, linear actuators, such as a screw drive, a belt driven design, or bidirectional solenoids.

Mounting Bracket: The mounting bracket functions to secure the actuator to the machine. Bracket design will vary depending upon the particular application.

Shift Linkage: The shift linkage functions to connect the actuator to the gearshift lever. The linkage style varies, depending upon the application, but is such that the linkage transmits the movement from the actuator to the gearshift lever to change the position of the pivot shaft and change gears in the transmission.

Wiring Harness: The function of the wiring harness is to channel current from the vehicle's electrical system, through the switch, to the actuator. The wiring harness configuration varies, depending upon the application, the actuator type, and the switch type.

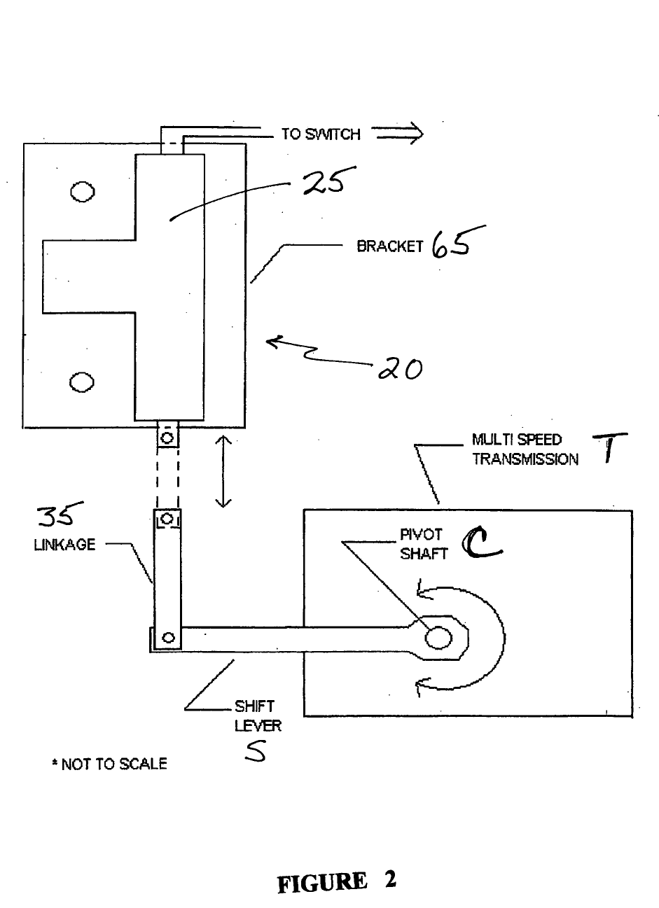

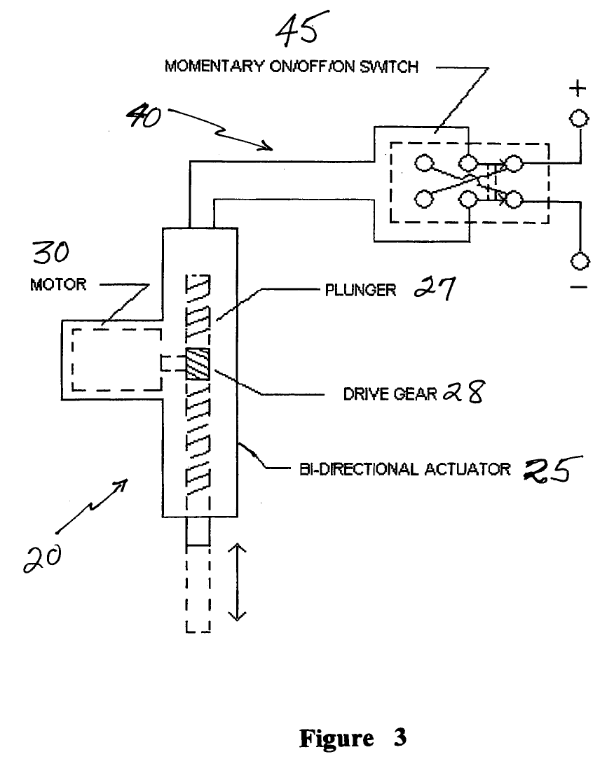

Referring now to the Figures, one embodiment of the invention is illustrated in greater detail. The invention is an electromechanical shifting apparatus 10 for a vehicle V having an electrical system and a transmission T equipped with a counter shaft C, utilizing partial rotation to shift gears. The shifting apparatus 10 comprises an actuator assembly 20 that includes a bidirectional linear actuator member 25 powered by an electrical motor 30, with the actuator assembly 20 secured to a frame F of the vehicle V. A shift linkage 35 operatively connects the bidirectional linear actuator member 25 to the counter shaft C of the vehicle transmission T. As illustrated in FIGS. 2 and 3, movement of the plunger member 27 by the drive gear 28, connected to the electric motor 30, in one direction (upwardly), moves the shift lever S upwardly via the shaft linkage 35 to upshift the transmission T. Similarly, movement of the plunger member 27 in the opposite direction (downwardly), moves the shift lever S downwardly, via the shift linkage 35, to downshift the transmission T.

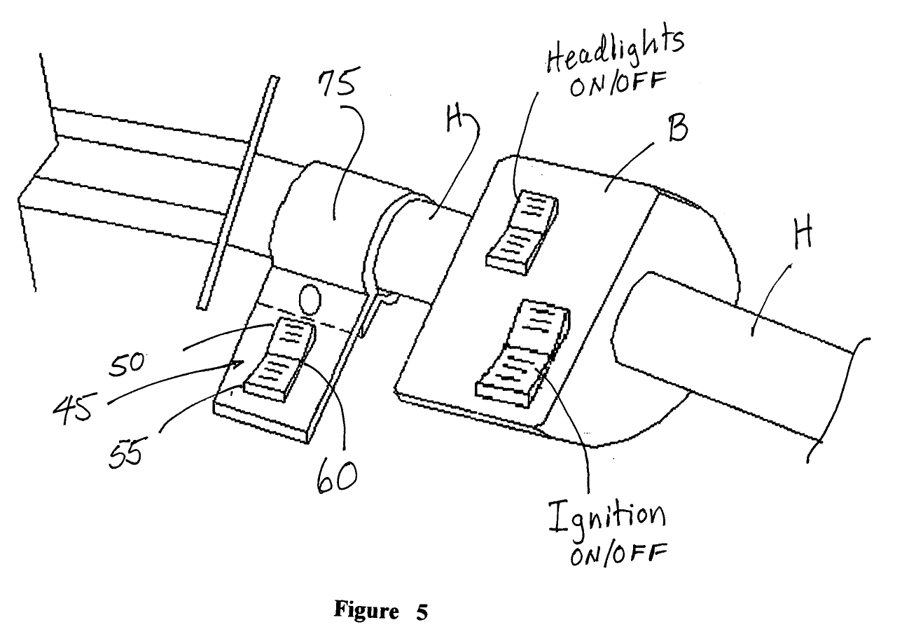

A wiring harness assembly 40 is connected to the electrical system of the vehicle V, with the wiring harness assembly 40 powering the electrical motor 30 of the actuation assembly. Referring now to FIG. 5, a switch member 45 is interconnected with the wiring harness 40, the switch member 45 including a first actuation position 50, a second actuation position 55 and an off position 60. The first actuation position 50 provides a selected current flow direction to the actuator assembly motor 30 to drive the linear actuator member 25 in a first direction. The second actuation position 55 reverses the current flow direction to the actuator assembly motor 30 relative to the selected current flow direction, thereby driving the linear actuator member 25 in a second direction, opposite the first direction. The switch member 45 of FIG. 5 includes a first actuation position 50 achieved by depressing the switch end adjacent the handle bar H. The second actuation position 55 is achieved by depressing the switch end opposite the handle bar H. An off position 60 is the normal, at rest, position for the switch and is achieved without depressing either end of the switch 45. Thus, an operator can upshift or downshift the vehicle transmission T by selectively pressing on the switch member 45.

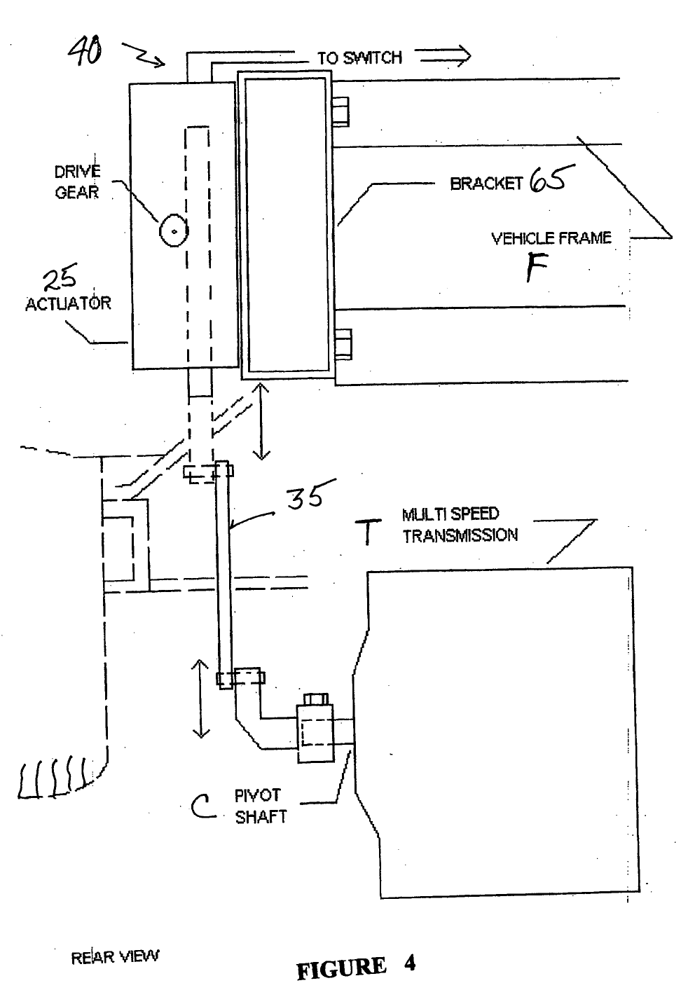

In a further embodiment of the invention, the linear actuator assembly 25 is secured to the vehicle frame F by a mounting bracket member 65, as shown in FIGS. 2 and 4. The mounting bracket member 65 provides a secure base for attachment of the linear actuator assembly 25 to the vehicle frame F, so that the actuator member 25 can move the shift lever S via the shift linkage 35.

In a preferred embodiment of the invention, the bidirectional, linear actuator member 25 includes a gear drive 70 to effect movement of the counter shaft C of the transmission T, as illustrated in FIGS. 3 and 4. Preferably, the switch member 45 is either a double pole double throw switch member, or a momentary on/off/on momentary switch member, as illustrated schematically in FIG. 3.

In a further embodiment of the invention, a switch mounting bracket 75 is present for mounting the switch member 45 to the vehicle frame F, as shown in FIG. 5. Most preferably, the switch mounting bracket 75 and switch member 45 are mounted to a steering handle bar H of the vehicle V, providing easy access to the hand of the operator. Also shown in FIG. 5 is a switch block B containing additional control switches. For example, one switch of the switch block B is an on/off switch for the engine, and the other switch of the switch block B is an on/off switch for the headlights.

While the invention has been particularly shown and described with reference to a preferred embodiment thereof, it will be understood by those skilled in the art that various changes in form and details may be made therein without departing from the spirit and scope of the invention.

I claim:

1. An electromechanical shifting apparatus for a vehicle having an electrical system and a transmission equipped with a counter shaft utilizing partial rotation to shift gears, the shifting apparatus comprising;
(a) an actuator assembly including a bidirectional, linear actuator member powered by an electrical motor, the actuator assembly secured to a frame of the vehicle;
(b) a shift linkage operatively connecting the bidirectional, linear actuator member to the counter shaft of the vehicle transmission;
(c) a wiring harness assembly connected to the electrical system of the vehicle, the wiring harness assembly powering the electrical motor of the actuation assembly; and
(d) a switch member interconnected with the wiring harness, the switch member including first and second actuation positions and an off position, the first actuation position providing a selected current flow direction to the actuator assembly motor to drive the linear actuator member in a first direction and the second actuation position reversing the current flow direction to the actuator assembly motor relative to the selected current flow direction, thereby driving the linear actuator member in a second direction opposite the first direction.

2. The electromechanical shifting apparatus of claim 1, wherein the actuator assembly is secured to the vehicle frame by a mounting bracket member.

3. The electromechanical shifting apparatus of claim 1, wherein the bidirectional linear actuator member includes a gear drive.

4. The electromechanical shifting apparatus of claim 1, wherein the bidirectional linear actuator member includes a screw drive.

5. The electromechanical shifting apparatus of claim 1, wherein the bidirectional linear actuator member includes a belt drive.

6. The electromechanical shifting apparatus of claim 1, wherein the switch member includes a double pole double throw switch member.

7. The electromechanical shifting apparatus of claim 1, wherein the switch member includes a momentary on/off/on momentary switch member.

8. The electromechanical shifting apparatus of claim 1, further including a switch mounting bracket for mounting the switch member to the vehicle frame.

9. The electromechanical shifting apparatus of claim 1, wherein the switch member is mounted to a steering handle bar of the vehicle.

10. An electromechanical shifting apparatus for a vehicle having an electrical system and a transmission equipped with a counter shaft utilizing partial rotation to shift gears, the shifting apparatus comprising;
(a) an actuator assembly including a gear drive, bidirectional, linear actuator member powered by an electrical motor, the actuator assembly secured to a frame of the vehicle;
(b) a shift linkage operatively connecting the bidirectional, linear actuator member to the counter shaft of the vehicle transmission;
(c) a wiring harness assembly connected to the electrical system of the vehicle, the wiring harness assembly powering the electrical motor of the actuation assembly; and
(d) a switch member interconnected with the wiring harness, the switch member including first and second actuation positions and an off position, the first actuation position providing a selected current flow direction to the actuator assembly motor to drive the linear actuator member in a first direction and the second actuation position reversing the current flow direction to the actuator assembly motor relative to the selected current flow direction, thereby driving the linear actuator member in a second direction opposite the first direction.

11. The electromechanical shifting apparatus of claim 10, wherein the actuator assembly is secured to the vehicle frame by a mounting bracket member.

12. The electromechanical shifting apparatus of claim 10, wherein the switch member includes a double pole double throw switch member.

13. The electromechanical shifting apparatus of claim 10, wherein the switch member includes a momentary on/off/on momentary switch member.

14. The electromechanical shifting apparatus of claim 10, further including a switch mounting bracket for mounting the switch member to the vehicle frame.

15. The electromechanical shifting apparatus of claim 10, wherein the switch member is mounted to a steering handle bar of the vehicle.

16. An electromechanical shifting apparatus for a vehicle having an electrical system and a transmission equipped with a counter shaft utilizing partial rotation to shift gears, the shifting apparatus comprising;
(a) an actuator assembly including a gear drive, bidirectional, linear actuator member powered by an electrical motor, the actuator assembly mounted to a bracket secured to a frame of the vehicle;
(b) a shift linkage operatively connecting the bidirectional, linear actuator member to the counter shaft of the vehicle transmission;
(c) a wiring harness assembly connected to the electrical system of the vehicle, the wiring harness assembly powering the electrical motor of the actuation assembly; and
(d) a switch member interconnected with the wiring harness, the switch member mounted to a bracket secured to a steering handle bar of the vehicle, the switch member including first and second actuation positions and an off position, the first actuation position providing a selected current flow direction to the actuator assembly motor to drive the linear actuator member in a first direction and the second actuation position reversing the current flow direction to the actuator assembly motor relative to the selected current flow direction, thereby driving the linear actuator member in a second direction opposite the first direction.

17. The electromechanical shifting apparatus of claim 16, wherein the switch member includes a double pole double throw switch member.

18. The electromechanical shifting apparatus of claim 16, wherein the switch member includes a momentary on/off/on momentary switch member.
